(19) United States
(12) Patent Application Publication
(10) Pub. No.: US 2014/0330605 A1
(43) Pub. Date: Nov. 6, 2014

(54) SYSTEM AND METHOD FOR MONITORING AND SCHEDULING A WORKFORCE

(71) Applicant: General Electric Company, Schenectady, NY (US)

(72) Inventors: PAUL CONNOLLY, Erie, PA (US); AARON MITTI, Atlanta, GA (US); MARTIN PAGET, Jacksonville, FL (US)

(73) Assignee: General Electric Company, Schenectady, NY (US)

(21) Appl. No.: 14/242,941

(22) Filed: Apr. 2, 2014

Related U.S. Application Data
(63) Continuation-in-part of application No. 13/886,396, filed on May 3, 2013.

(51) Int. Cl. G06Q 10/06

(52) U.S. Cl. CPC G06Q 10/063116
USPC 705/7.16

(57) ABSTRACT

A method includes calculating a labor shortfall for completion of a set of tasks within a designated time period. The labor shortfall represents a difference between a required workforce that is needed to complete the tasks and an amount of available workforce. The available workforce personnel are subject to workforce constraints on how long the workforce personnel can work. The method also includes visually presenting an indication of the labor shortfall and automatically generating communication signals for available workforce personnel and/or additional workforce personnel. The communication signals request additional work on the set of tasks by the at least one of the available workforce personnel or the additional workforce personnel in excess of the one or more workforce constraints.

### CROSS-REFERENCE TO RELATED APPLICATIONS

This application is a continuation-in-part of U.S. patent application Ser. No. 13/886,396, filed on 3-May-2013, and entitled “System And Method For Scheduling,” the entire disclosure of which is incorporated by reference.

### FIELD

The subject matter disclosed herein relates to systems and methods of determining a schedule for performing tasks on one or more assets, scheduling a workforce to complete the tasks, and/or monitoring the workforce during performance of the tasks.

### BACKGROUND

Transportation systems may include a variety of assets, such as traffic control devices, tracking systems, and vehicles. In a railroad environment, such assets may include wayside devices, grade crossing devices, locomotives, and railcars. These assets may need periodic inspection. Inspections may be based on government requirements, manufacturer recommendations, or industry standards that can align with reliability, safety, and performance goals. The inspection requirements may be met by members of the workforce, but which have various limitations and restrictions on their availability, cost, and capabilities of individual members of the workforce plus the availability of the asset, and/or required inspection equipment. There is a burden associated with planning and managing inspections based on the number of assets, number of inspections, and variable workforce capacity. Furthermore, the workforce capacity may fluctuate due to a variety of circumstances, such as demands on the workforce to address emergency or high priority tasks not associated with inspection activities, overtime work, limitations placed on available working hours such as Hours of Service regulations, or other workforce constraints. It may be desirable to have a system for determining a schedule for performing inspection tasks that differs from the systems and methods that are currently available.

Additionally, limitations on a workforce, such as contractual limitations on how long personnel have agreed to work on the tasks (e.g., collective bargaining agreements), can have a significant impact on whether a scheduled set of tasks can be completed within a desired period of time. If additional work is needed, the work may be obtained in certain circumstances by requesting overtime or other excess work. But, obtaining the overtime work frequently involves procedures seeking the persons willing to work the additional time, obtaining permission for those persons to work the additional time, and so on. As a result, the delay in obtaining the additional work can delay completion of the scheduled set of tasks.

### BRIEF DESCRIPTION

In one example of the inventive subject matter described herein, a method (e.g., for monitoring and/or scheduling a workforce) includes calculating, with one or more computer processors, a labor shortfall for completion of a set of tasks within a designated time period. The labor shortfall represents a difference between an amount of required workforce personnel that is needed to complete the set of tasks within the designated time period and an amount of available workforce personnel during the designated time period. The available workforce personnel are subject to one or more workforce constraints on how long the available workforce personnel can work within the designated time period. The method also includes visually presenting, with the one or more computer processors on an electronic device of an operator, an indication of the labor shortfall, and responsive to receiving first operator input on the electronic device of the operator, automatically generating one or more communication signals that are sent to one or more mobile devices of at least one of the available workforce personnel or additional workforce personnel. The one or more communication signals request additional work on the set of tasks by the at least one of the available workforce personnel or the additional workforce personnel in excess of the one or more workforce constraints.

In another example of the inventive subject matter described herein, a system (e.g., for scheduling and/or monitoring a workforce) includes a controller (having one or more computer processors) that is configured to identify a labor shortfall for completion of a set of tasks within a designated time period. The labor shortfall represents a difference between an amount of required workforce personnel that is needed to complete the set of tasks within the designated time period and an amount of available workforce personnel during the designated time period, the available workforce personnel subject to one or more workforce constraints on how long the available workforce personnel can work within the designated time period. The controller also is configured to direct an electronic device of an operator to visually present an indication of the labor shortfall, and to receive first operator input via the electronic device of the operator and, responsive to receiving the first operator input. The controller is further configured to automatically generate one or more communication signals that are sent to one or more mobile devices of at least one of the available workforce personnel or additional workforce personnel. The one or more communication signals request additional work on the set of tasks by the at least one of the available workforce personnel or the additional workforce personnel in excess of the one or more workforce constraints.

In another example of the inventive subject matter described herein, another method (e.g., for scheduling and/or monitoring a workforce) includes estimating a needed amount of workforce personnel to complete a scheduled set of tasks on a vehicle asset to at least one of repair the vehicle asset, maintain the vehicle asset, or prepare the vehicle asset for departure, determining an available amount of the workforce personnel that can perform at least part of the scheduled set of tasks within an upcoming designated time period subject to one or more workforce constraints on a length of time that the workforce personnel is allowed to work during the upcoming designated time period, comparing the needed amount of the workforce personnel with the available amount of the workforce personnel to identify a labor shortage for the scheduled set of tasks, notifying an operator of the labor shortage on an electronic mobile device of the operator, and, responsive to receiving input from the operator via the mobile device of the operator, at least one of: identifying additional workforce personnel to assist with performance of the scheduled set of tasks in excess of the one or more workforce constraints in order to reduce or eliminate the labor shortage, or changing a scheduled order of the tasks to reduce or eliminate the labor shortage.

In an embodiment, a method comprises receiving asset information for a plurality of assets; each asset has respective defined inspection requirements. The method further comprises determining a respective list of inspection tasks for each of the plurality of assets based on the inspection requirements, and receiving workforce information for a plurality of members of a workforce who perform the inspection tasks on the assets. The workforce information further includes one or more workforce constraints. The method further comprises determining a schedule for the inspection tasks based on the asset information and the workforce information, subject to the workforce constraints.

Also disclosed is a system that includes a controller, an asset database system containing asset information for a plurality of assets, an inspection requirements database system, and a workforce database system. The inspection requirements database system contains information of defined inspection requirements of the plurality of assets. The controller is configured to generate inspection tasks for the plurality of assets based on the defined inspection requirements. The workforce database system contains workforce information for a plurality of members of a workforce who perform the inspection tasks on the assets. The workforce information further includes workforce constraints. The controller is configured for communication with the asset database system, the inspection requirements database system, and the workforce database system. The controller is operable to determine a schedule for the inspection tasks based on the asset information and the workforce information, subject to one or more of the workforce constraints, equipment constraints, or environmental constraints.

### BRIEF DESCRIPTION OF THE DRAWINGS

Reference is made to the accompanying drawings in which particular embodiments of the inventive subject matter are illustrated as described in more detail in the description below, in which:

FIG. 1 is a schematic block diagram of an exemplary embodiment of a system for determining a schedule for performing inspection tasks on a plurality of assets;

FIG. 2 is a flowchart of an exemplary embodiment of a method for determining a schedule for performing inspection tasks on a plurality of assets;

FIG. 3 is a schematic block diagram of an embodiment of a system illustrating aspects of the inventive subject matter;

FIG. 4 illustrates one example of a workforce device shown in FIG. 3;

FIG. 5 illustrates one example of a status presentation that can be visually presented on one or more of the workforce devices shown in FIG. 3 according to one aspect of the inventive subject matter described herein;

FIG. 6 illustrates a timeline representation of a set of tasks scheduled in a first order according to one example of the inventive subject matter described herein;

FIG. 7 illustrates a timeline representation of the same set of tasks scheduled in a different order according to one example of the inventive subject matter described herein;

FIG. 8 illustrates another example of a status presentation that can be visually presented on one or more of the workforce devices shown in FIG. 3 according to one aspect of the inventive subject matter described herein; and

FIG. 9 is a flowchart of a method for monitoring and/or scheduling a workforce according to one example of the inventive subject matter described herein.

### DETAILED DESCRIPTION

Embodiments of the present disclosure relate to systems and methods for scheduling a workforce to perform tasks on a plurality of assets. The systems and methods described herein are illustrated in the context of a railroad environment including both mobile assets, such as rail cars, and fixed assets, such as crossings and switches. Embodiments of the inventive subject matter however may also be applied to other industries or environments, for example, shipping ports, warehouses, or commercial vehicle fleets, along with their corresponding assets.

The term “asset” refers to stationary equipment and mobile equipment. Examples of assets include, but are not limited to, gates and crossings on a rail line, vehicles (such as, mining equipment, marine vessels, aircraft, automobiles, and locomotives), containers/trailers, office equipment (such as printers and electronic devices), industrial equipment (such as power generators and motors), and military and construction equipment.

Asset information can include informational items such as the type of asset, serial numbers, and the asset history, asset status, and/or asset health. For example, the asset status can include whether the asset is in-service, out-of-service, retired, or the like.

The term “inspection requirement” refers to a task that is designated to be performed on or in connection with an asset. Some inspection requirements may be imposed by government regulation. Inspection requirements may come from the asset manufacturer or service provider, and may sometimes be coupled with a warranty or guarantee. Other inspection requirements may be defined through standard operating procedures established by an industry. Inspection requirements may be defined by previous inspection history or maintenance/repair history and may change over an expected life of an asset, with different requirements being associated with different points along that product life. Inspection requirements may include one or more of observation, testing, repairing/replacing, updating, cleaning, preventative maintenance, record keeping or data collection, or other tasks.

The term “workforce” refers to individuals expected to perform the inspection tasks corresponding to the inspection requirements. The term “inspection equipment” refers collectively to resources (such as replacement parts) and test equipment needed by the individual(s). The term “work conditions” includes external aspects necessary to perform an inspection, such as availability of road or track time, garage space, fuel, computer/communication/data access, and/or the environment (such as weather conditions).

The term “workforce constraints” may be applied to the individuals, the inspection equipment, or the work conditions. Regarding the individuals, it may include limits on the availability of the individuals to perform the inspection tasks corresponding to the inspection requirements; may be temporal, such as designated days or hours when a given worker is unavailable; or may be a capability limitation. A capability limitation may include lack of certification, lack of training, lack of necessary equipment, or other limitations imposed on various members of the workforce, such as hours of service requirements or similar regulations. (For example, some hours of service regulations are defined in the U.S. under Title 49, Part 228; 49 CFR 228.) A workforce constraint on an individual may be a limitation on the types of tasks or work that an individual is expressly or implicitly contracted to do. For example, some individuals may be subject to contracts or agreements that prevent the individuals from performing some tasks. As applied to inspection equipment, it may include limits on the availability, or it may be geographic or functional limitations (such as needing data communication connectivity), or may be configuration-based (such as needing an adapter plug or a software patch). Environmental workforce constraints may include weather, particularly temperature, humidity, and light levels—and these may be further based on considerations for the safety or comfort of the individual or may be elements of the inspection (an electrical test may be precluded on rainy days unless shelter is available, for example).

Workforce constraints further may be designated as hard or soft constraints. A hard constraint is one that may not be overridden, such as the unavailability of a given worker due to illness. A soft constraint is one which may be able to be overridden, such as a preferred or contractually agreed to maximum work hours in a given day, continuous working time period, or other time period that may be exceeded by allowing for overtime and incurring additional cost. In addition, workforce constraints may be short-term limitations, such as a planned vacation day. Alternatively, workforce constraints may represent long-term limitations, such as an employee's job code that defines what tasks the employee is available to perform. Another example of a workforce constraint may be limitations on the availability of persons having one or more designated or needed areas of expertise for a given time period.

“Software” or “computer program” as used herein includes, but is not limited to, one or more computer readable and/or executable instructions that cause a computer, controller or other electronic device to perform functions, actions, and/or behave in a desired manner. The instructions may be embodied in various forms such as routines, algorithms, modules or programs including separate applications or code from dynamically linked libraries. Software may be implemented in various forms such as a stand-alone program, a function call, a servlet, an applet, an application, instructions stored in a memory, part of an operating system or other type of executable instructions.

“Computer”, “processing element”, “controller”, “device”, or “system” as used herein includes a programmed or programmable electronic device that can run software. For example, a computer, processing element, controller, or device may include hardware circuits or circuitry that include and/or are connected with one or more computer microprocessors.

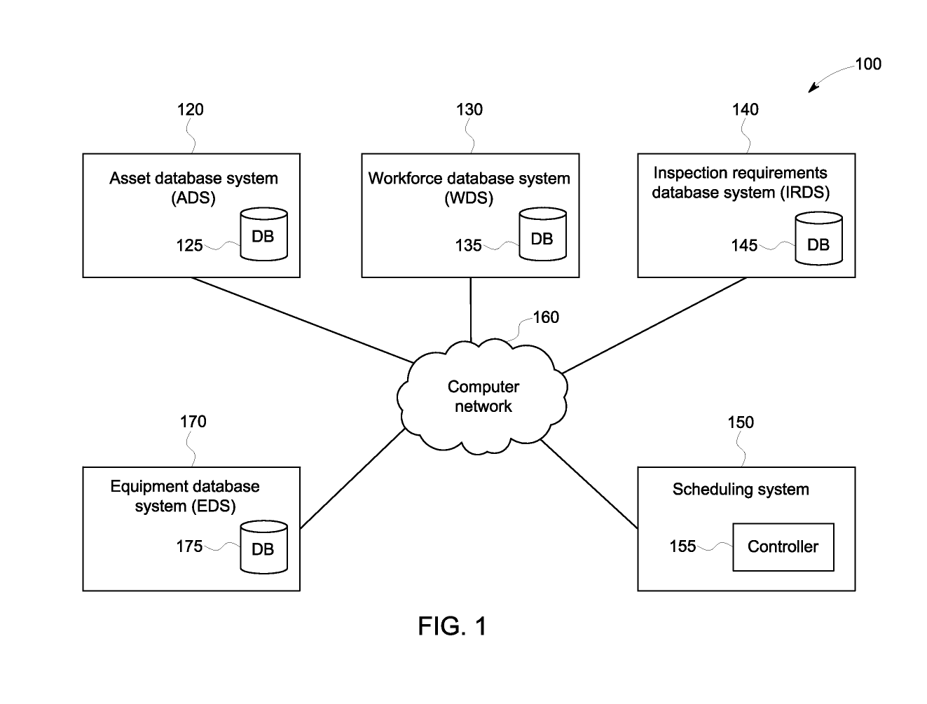

FIG. 1 is a schematic block diagram of an embodiment of a system 100 illustrating aspects of the inventive subject matter. The system may schedule a workforce to complete inspection requirements on a plurality of assets. The system includes an asset database system (ADS) 120 having at least one database (DB) 125. The ADS contains asset information for a plurality of assets that each have respectively defined inspection requirements. The system has an inspection requirements database system (IRDS) 140 having at least one database (DB) 145. The IRDS contains inspection requirements from which inspection tasks are generated for the assets represented in the ADS. The system also includes a workforce database system (WDS) 130 having at least one database 135. The WDS contains workforce information for a plurality of members of a workforce who perform the inspection tasks on the plurality of assets. The WDS may also contain workforce constraints. The system also can include an equipment database system (EDS) 170 having at least one database (DB) 175. The EDS includes information on the availability of equipment, tools, facilities, or the like, for use in performing the tasks on the assets (e.g., inspection tasks or other tasks). For example, the DB 175 can store data representative of which tools, equipment, facilities, or the like, are available for use in performing tasks; when the tools, equipment, facilities, or the like, will be available; when the tools, equipment, facilities, or the like, will not be available; where the tools and/or equipment are located; when the tools and/or equipment will be at a designated location; and/or other information. In embodiments, the ADS, IRDS, WDS, and/or EDS may be implemented in a single database system or implemented in two or more database systems as desired.

The ADS, the IRDS, the WDS, and/or the EDS communicate with a scheduling system 150 having a controller 155. The controller 155 may include one or more processors, such as one or more computer microprocessors that are included within or connected to hardware circuits or circuitry. Using the information from the ADS, IRDS, WDS, and/or EDS, the scheduling system determines an inspection task schedule based on at least the asset information, inspection tasks, and the workforce information, subject to the workforce constraints. For example, the controller 155 may be configured to generate inspection tasks for the plurality of assets based on the defined inspection requirements, and to determine a schedule for the inspection tasks based on the asset information and the workforce information, subject to one or more of the workforce constraints, equipment constraints, or environmental constraints.

In an embodiment, the system is applied to railroad assets. Each asset may be represented in the ADS by one or more records that contain pertinent information about the asset. For example, the asset may have a unique identifier. The asset may also be assigned an asset type, where inspection requirements are specific to the asset type. For example, assets of the type “switch” may require certain inspections, whereas assets of the type “signaling device” may require different inspections. In addition, fixed assets may have a defined geographic location. Mobile assets, such as rail cars, may have a defined geographic location, which may be the most recent location, a projected location, or a series of projected locations representing where the mobile assets are expected to be at a given time. In some embodiments, the system communicates with an asset and receives data from the asset corresponding to the geographic location of the asset. The asset may also communicate vector data such as the direction of travel and speed of the asset, which may be used to project the location of the asset at a future time. In yet other embodiments, an operator of an asset may communicate the asset's current location, and may communicate an expected location for the asset at a future time. The location information received or estimated by the system may be used in determining the schedule for inspection tasks.

Each asset may have one or more inspection requirements. By way of illustration, the inspection of certain railroad assets is required according to governmental regulations that establish inspections which must be performed on a periodic basis. A given asset may have a 30-day inspection having a first list of tasks, a 90-day inspection requirement having a second list of tasks, and a 360-day inspection requirement having a third list of tasks. The tasks may be different for each type of inspection, and for each type of asset. For some assets, each 30-day inspection must be performed no later than 30 days after the preceding 30-day inspection. Similarly, each 90- and 360-day inspection must be performed no later than 90- or 360-days following the preceding 90- or 360-day inspection, respectively. Consequently, for an asset with 30-day, 90-day and 360-day inspection requirements, a member of the workforce may be required to visit that asset at least 12 times during any given 360-day period. In this example, only one asset with only three inspection requirements was considered. A railroad environment, however, may have many assets each having many inspection requirements. Moreover, multiple assets may be co-located, such as multiple gates and signals at a given railroad crossing. The ADS 120 in combination with the IRDS 140 contains information about each of these assets allowing the scheduling system 150 to determine a list of inspection tasks for each of the plurality of assets based on the inspection requirements for each asset. The scheduling system 150 may then determine a schedule for the inspection tasks to be performed.

The inspection tasks described above are performed by members of a workforce. The members of the workforce may be employees, contractors, or any other personnel to be scheduled by the scheduling system 150. In some embodiments, various inspection tasks may require special inspection equipment or track time, and the inspection equipment or availability of track time may be regarded as a member of the workforce. In these embodiments, the workforce may include both people and equipment necessary to perform the inspection tasks.

The workforce information stored in the WDS 130 (or associated DB) also includes information about the members of the workforce that may be used to determine a schedule for the inspection tasks. In one embodiment, the workforce information includes an hourly rate for each member of the workforce. The scheduling system 150 may thus compute an expected cost for a given member of the workforce to perform a given inspection task based on the expected duration of the task and that member's hourly rate. Similarly, the workforce information may include overtime hourly rates for those members who are eligible to work overtime. In other embodiments, the workforce information may also include details of union agreements relating to tasks that may be performed by each member of the workforce, the hours each member may be asked to work, or other factors relative to the scheduling of the workforce to perform the inspection tasks. The workforce information may also include data representing the skill set and qualifications of a given member of the workforce. In addition, the workforce information may include an efficiency or expertise rating. The efficiency or expertise rating may be used to project the time required for a given employee to complete a task. For example, a member of the workforce may have an efficiency factor of 1.25 indicating that this employee is 25% more effective at completing certain tasks due to experience, training, knowledge of certain territories or equipment, or the like. The scheduling system 150 may use the efficiency or expertise rating, in combination with other workforce information, to more accurately project the time required for the completion of certain tasks by different employees. The workforce information may be updated over time to reflect changes in hourly rates, skill sets, qualifications, efficiency and expertise rating, or other factors to improve the scheduling process.

As previously discussed, the workforce constraints impose limitations on the availability or allocation of members of the workforce to the inspection tasks. In a railroad environment, maintenance personnel may be subject to a limitation on the number of hours that a given employee may work in any period. Similarly, personnel may be required to have a minimum number of hours off-duty in between shifts. The workforce information includes these and other workforce constraints that may be factored into the scheduling of inspection tasks. In addition, information specific to a given individual may be included as a workforce constraint. For example, an individual may be unavailable due to illness, vacation, training or any other reason that effectively removes the individual from the pool of members available to perform the inspection tasks.

Based at least on the asset information and the workforce information, the scheduling system 150 determines a schedule for the inspection tasks subject to the workforce constraints. In one embodiment, the scheduling system 150 determines the schedule for the inspection tasks, at least in part, by reducing an expected cost for the workforce to perform the inspection tasks on the assets. The expected cost for the workforce to perform the inspection tasks may be calculated using the determined list of inspection tasks for each asset and the workforce information. In one example, the expected cost for a 30-day inspection task is determined by the expected duration of that task and the hourly rate of the workforce member scheduled to complete the task. If a workforce member with a different hourly rate is assigned to the task, the expected cost for that task may increase or decrease accordingly. In a similar manner, an efficiency or expertise factor may be applied to adjust the expected time to complete the task. The time and labor rates for various members of the workforce may be analyzed to reduce the expected cost for performing the inspection tasks on the assets. In one embodiment, the expected cost for a given task may be equal to the hourly rate multiplied by the expected time and divided by the efficiency factor for the employee assigned to the task. In other embodiments, the expected cost may be determined, at least in part, based on factors such as determining the best utilization of a reduced workforce size, minimizing travel cost or minimizing fuel consumption to reduce carbon emissions. In yet other embodiments, the expected cost may be determined, at least in part, based on a compliance risk factor that increases the expected cost when a test is completed on the last day the test is due. In this manner, objectives for human and physical resource allocation as well as schedule or compliance priorities may be incorporated into the expected cost analysis allowing the system to determine a schedule based upon multiple considerations.

By allocating workforce members to the inspection tasks, the scheduling system determines an expected cost for the workforce to perform the inspection tasks. In embodiments, the scheduling system reduces the expected cost for the workforce to perform the inspection tasks by changing the sequence of the tasks and/or the allocation of workforce members to specific tasks. As discussed above, a given asset may have 30-day, 90-day, and 360-day inspection requirements resulting in at least 12 visits to the asset by a member of the workforce. In prior systems, the 90-day and 360-day inspections may have been scheduled to coincide with the 30-day inspections on the assumption that performing multiple inspections on a single visit to an asset would produce an efficient schedule. The presently disclosed system, however, considers multiple factors as discussed above, and may produce an improved schedule as compared to the prior systems. In one example, the system may accelerate an inspection of a certain first asset to coincide with an inspection due on a second asset located in close proximity to the first asset. In this manner, the system considers inspection requirements for the plurality of assets to determine an improved schedule for the collection of assets as a whole. In one embodiment, the system improves upon the schedule by generating a first work schedule for the workforce to perform inspection tasks subject to the workforce constraints and asset inspection requirements, and then generating a second work schedule where the expected cost for the workforce to implement the second work schedule is less than an expected cost for the workforce to implement the first work schedule. The system may continue to generate successive work schedules with iteratively lower expected costs until an acceptable schedule is achieved.

In some embodiments, the scheduling system 150 forecasts future inspection tasks for each of the plurality of assets based on the inspection requirements. Future inspection tasks may be defined as those inspection tasks beyond a certain date, whereas current inspection tasks are those that fall prior to the date. Alternatively, future inspection tasks may be those tasks which are contingent upon completion of a task that has not yet been performed. In various embodiments, the system may determine a schedule for the inspection task at least in part, by reducing an expected cost for the workforce to perform both the current inspection tasks and the future inspection tasks. By dividing tasks into current, or near term tasks, and future, or longer term tasks, the schedule may be adjusted to balance both near term and longer term costs. In yet another embodiment, the scheduling system generates both a current work schedule and a future work schedule for the workforce to perform a current asset inspection subject to the workforce constraints and asset inspection requirements. The scheduling system may then modify the current work schedule to reduce an expected cost for the workforce to implement the future work schedule.

In yet another embodiment, each of the plurality of assets have a designated geographic location and the scheduling system 150 determines the schedule for the inspections by reducing a travel cost for the workforce in performing the inspection tasks on the plurality of assets at the designated geographic locations. Similar to the assets, members of the workforce may also have designated geographic locations reflecting the location of each member. In this manner, the travel cost, including distance and time, and in some embodiments other factors such as traffic conditions or estimated carbon emissions, may be factored into the determination of the schedule. In an embodiment, the scheduling system 150 allocates workforce members to inspection tasks to reduce the total travel cost for each member of the workforce. In embodiments with mobile assets, the scheduling system 150 may project the locations of both the mobile assets and the workforce members over time, and allocate workforce members to inspection tasks on mobile assets when the travel cost between the projected locations is reduced. By combining location information with other factors discussed above, the scheduling system 150 may provide an efficient schedule for the completion of the inspection tasks by the workforce. In an embodiment, at least a portion of the assets have a fixed geographic location, and the schedule for the inspection tasks may be determined by calculating a travel cost for the workforce to travel from a first location of the workforce, such as the workforce member's current location, to the fixed geographic location of the one or more assets to perform the inspection tasks on the plurality of assets. In another embodiment, at least a portion of the assets are mobile assets with variable geographic locations, and the schedule for the inspection tasks is determined, at least in part, by calculating a travel cost for moving an asset from its current location to a designated location, such as a repair depot, where the workforce may perform the required inspection task for the asset. In yet another embodiment, both the workforce and the assets may be mobile, and the schedule for the inspection tasks is determined by calculating a travel cost for moving one or both of the workforce and the assets to a designated location where the workforce may perform the inspection tasks on the asset. In this manner, the system is able to construct a schedule that accommodates both asset and workforce locations and that improves the efficiency of the schedule by taking into account the relationship between asset locations and the locations where inspection tasks are to be performed.

Over time, the system 100 receives updated asset information and workforce information. For example, upon completion of an inspection task for a given asset, the workforce member may update the asset database to reflect the completion of the inspection task. In one embodiment, upon updating the asset database the workforce member records the actual time required for that workforce member to perform the inspection task. Over time, the system may adjust the estimated time required for a given inspection task on a given asset based upon the actual performance of that task by members of the workforce. In addition, the workforce information may be updated to reflect the relative efficiency of different members of the workforce in performing certain types of inspection tasks. The feedback of actual performance data into the asset information and workforce information may enable the system to more accurately estimate the expected cost for performing the inspection tasks. In some embodiments, the system may require a workforce member to update asset information when that workforce member is in proximity to that asset. The system may thus provide a safeguard against incorrect updates and provide an audit trail demonstrating that the workforce member was at the designated geographic location of the asset when the inspection was performed.

In some embodiments, the system also receives requests for previously unscheduled tasks, such as repairs due to an unexpected failure of an asset. The need for an unscheduled task may be identified by an operator or technician, or may be triggered based on a fault signal or prognostic indicator associated with a condition of a monitored asset. An unscheduled task of this type may disrupt a previously established schedule, requiring a rescheduling of the workforce members to accommodate the unplanned work. In one embodiment, the system receives the unscheduled task and a deadline for completing the unscheduled task, and determines a new schedule for the workforce that includes the unscheduled task. In one embodiment, the new schedule is created within 60 seconds of receiving the unscheduled task so that the workforce may be promptly reprioritized pursuant to the new schedule. The system may further modify the schedule to recover the time lost due to the unscheduled task. This may involve reallocating workforce members or adjusting the sequence of tasks.

By forecasting inspection requirements and determining a schedule for both current and future inspection tasks, the system is able to proactively improve the efficiency and productivity of the workforce over time. The deadline for many inspection tasks is based upon the date when a prior inspection was completed. The system is able to forecast when future inspection(s) would be required based upon when current inspections are performed, allowing the system to drive inspections into a more efficient sequence. Further, by examining inspection requirements across the plurality of assets, the system is able to take into account the variety of assets and the variety of inspection requirements to generate an improved schedule. In a similar manner, the system may drive the alignment of tasks on multiple assets at a given location to improve the efficiency

In yet other embodiments, the system determines the schedule for performing inspection tasks based on forecasted weather conditions. In certain applications, it may not be possible to perform certain tasks under all weather conditions. Certain railroad inspections, for example, may not be performed in the rain or when the ambient temperature is outside a defined range. In these applications, the system may adjust the schedule based upon the forecast weather so that these weather-dependent tasks are scheduled for a time when the weather conditions are appropriate to the task.

In yet another embodiment, in addition to determining a schedule, the system may track the hours worked by one or more members of the workforce to monitor compliance with hours of service limitations. The hours of service limitation may be a hard constraint, such that when a workforce member has reached the limit, that member must discontinue working More often, however, the hours of service limitation is a soft constraint that may be overridden when necessary, such as when responding to emergency conditions or addressing urgent repairs. The system may monitor the hours of service and generate a report identifying any task or reason for any deviation from an hours of service constraint. The system may similarly monitor compliance with inspection requirements and generate a report to demonstrate compliance with the requirements. In some cases, it may not be possible to fully comply with all inspection requirements, in which case, the system may determine a schedule based upon the severity of non-compliance, including any expected fines or other liability.

In addition to scheduling workforce members, which may be persons and/or equipment, the scheduling system may also determine a schedule based on such factors as the availability of track time or on-rail test equipment (such as a locomotive or test car). In a railroad environment, some inspections require the workforce member to have access to the railroad track, or to know the availability and predicted arrival at the asset of the on-rail test equipment. The system may interface with a scheduling, dispatch, movement planning system, or other such similar system, to determine the location of trains and/or on-rail test equipment so that inspection tasks requiring track time may be performed when the track is available, or to determine when the on-rail test equipment will be available at the asset in order to minimize waiting time. In other embodiments, the system may interface with the movement planner to redirect trains to create available track time if necessary for the performance of an inspection task. In this manner, the system may be used in combination with other systems to efficiently manage a variety of fixed and/or mobile assets.

In embodiments, the scheduling system 150 receives the asset information and the workforce information and performs a sensitivity analysis on one or more of the factors previously discussed to determine the schedule for performing the inspection tasks. Using the results of the sensitivity analysis, the system 150 determines the factors which have the greatest impact on the schedule, such as by impacting the expected cost for the workforce to perform the inspection tasks. The system may produce one or more schedules, which may be adopted according to the preferences or criteria of a given business. In addition, one or more scheduled scenarios may be determined with different assumptions about workforce or equipment availability, increased or decreased inspection requirements, or other variations contemplated for the management of the assets. Used in this manner, the system provides a scenario-based planning tool to assist in evaluating the impact of changes in the assets and workforce to aid in the management process.

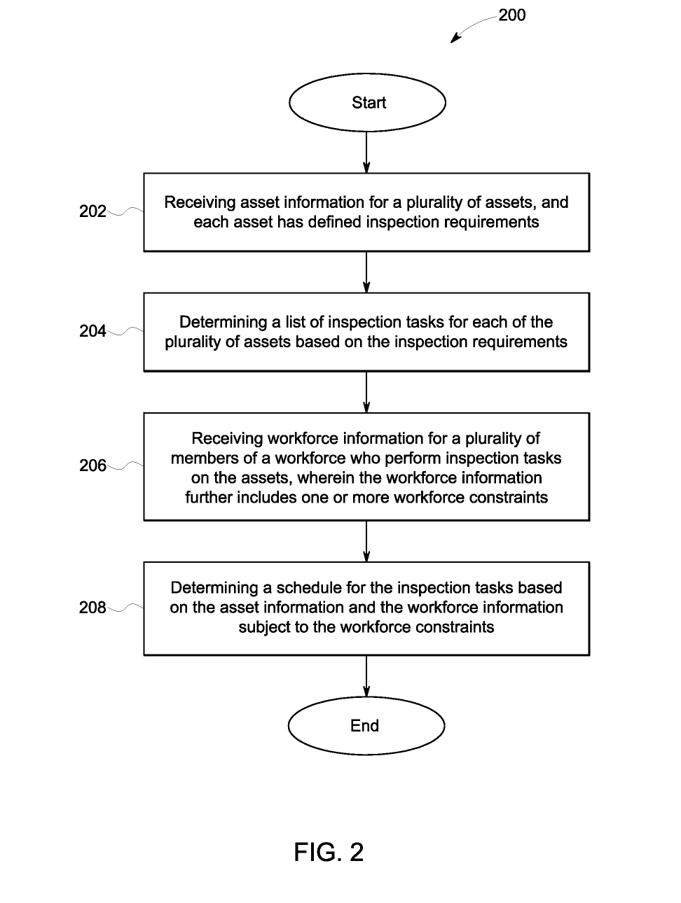

Referring now to FIG. 2, a flowchart of an exemplary embodiment of a method 200 for scheduling is illustrated. In step 202, asset information is received for a plurality of assets, and each asset has defined inspection requirements. In step 204, inspection tasks are determined for each of the plurality of assets based on the inspection requirements. These tasks can be performed prior to beginning work on the tasks and assets, or after work has begun on the tasks or assets. In step 206, workforce information is received for a plurality of members of a workforce who perform inspection tasks on the assets, and the workforce information further includes one or more workforce constraints. In step 208, a schedule is determined for the inspection tasks based on the asset information and the workforce information, subject to the workforce constraints. The method 200 may be performed by the system 100 illustrated in FIG. 1, and may be implemented as a computer program or using a combination of hardware and software resources.

In an embodiment, the system 100 determines the schedule for performing various inspections for the assets. The decision on when to perform each test or other task has an effect on the overall cost incurred in performing the required inspections. The system determines the schedule for all inspections in a given planning period while considering the constraints imposed by the inspection requirements and workforce constraints. In one embodiment, the system may use a mixed integer linear programming algorithm having an objective function to be reduced or minimized. A set of constraints may be communicated to the controller and the schedule determined based in part on the set of constraints. In an embodiment, the system initially determines a long term schedule for a long term planning period while approximating travel cost. The long term schedule may be determined to sequence the inspections to improve the cost of performing the work over a long duration, such as several weeks, months or even years. The system may then determine a short term schedule and improve the schedule to reduce costs by modeling actual travel cost for each member of the workforce. Due to the increased processing requirements, the short term schedule calculation is typically of less duration than the long term schedule. In embodiments, the short term schedule may extend for several days or weeks. The system may finally determine a daily schedule based upon the inspections that are scheduled for a given day. The daily schedule may reduce costs by determining a sequence in which inspections are to be performed so that the travel cost, as measured by one or more factors, is reduced. These factors may include fuel, distance, time, traffic conditions, weather, road or track conditions, and/or emissions levels. These emissions levels may include total exhaust levels, or may refer to one or more exhaust constituents (NOx, CO, SOx, particulate levels, and the like). The daily schedule, short term schedule, and long term schedule may be recomputed as the inspections requirements, assets, or workforce information change. In addition, the schedules may be updated based upon the completion of inspection tasks to further refine the schedule for future tasks.

In this manner the system generates a schedule for inspection tasks for one or more assets based at least in part on asset information of the assets, inspection requirements associated with the assets, and workforce information, subject to one or more of workforce constraints, equipment constraints and environmental constraints.

In another embodiment, a method comprises receiving, by one or more controllers, asset information for a plurality of assets; each asset has respective defined inspection requirements. The method further comprises determining, by the one or more controllers, a respective list of inspection tasks for each of the plurality of assets based on the inspection requirements, and receiving workforce information for a plurality of members of a workforce who perform the inspection tasks on the assets. The workforce information further includes one or more workforce constraints. The method further comprises determining, by the one or more controllers, a schedule for the inspection tasks based on the asset information and the workforce information, subject to the workforce constraints. The method may be automatically carried out by the one or more controllers. In other embodiments, the method additionally comprises carrying out the inspection tasks on the assets, according to the schedule, such that physical states of one or more of the assets are changed (e.g., from a state before inspection to a state after inspection).

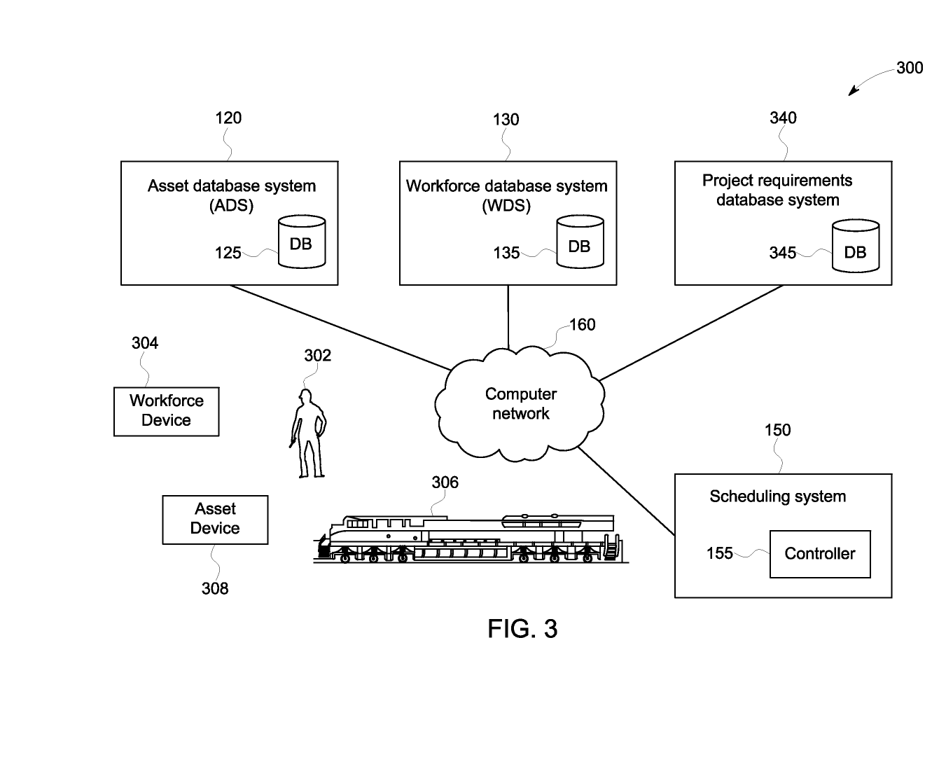

FIG. 3 is a schematic block diagram of an embodiment of a system 300 illustrating aspects of the inventive subject matter. The system may schedule a workforce (e.g., one or more human personnel 302) to complete inspection requirements on a plurality of assets 306. While the asset is shown in FIG. 3 as a locomotive, alternatively, the asset may be another type of vehicle, a non-vehicular system (e.g., an electro-mechanical system, electrical system, mechanical system, or the like), or another apparatus or assembly.

Similar to the system 100 shown in FIG. 1, the system 300 includes the ADS 120 having the DB 125. In one aspect of the inventive subject matter, the assets may include work requirements in addition to or in place of the inspection requirements. The work requirements represent one or more sets of tasks (e.g., projects, jobs, or the like) that are to be completed for the corresponding assets. These sets of tasks can be performed on the assets to inspect the assets, repair the assets, maintain the assets, prepare the assets for one or more missions (e.g., moving cargo toward a destination location), or the like. For example, one set of tasks may involve a series of tasks to be performed on a locomotive or other vehicle to ensure that the brakes are functioning properly on the locomotive or other vehicle, that the locomotive or other vehicle has sufficient fuel to complete an upcoming mission, that an onboard controller computer of the locomotive or other vehicle has the correct data needed to complete the mission, or the like. As another example, another set of tasks may involve a series of tasks to be performed on a locomotive or other vehicle to repair one or more components that have failed or that are trending toward failure (e.g., brake systems, engines, drive trains, wheel-axle set combinations, or the like). As another example, another set of tasks may involve a series of tasks to be regularly performed on a locomotive or other vehicle to maintain the locomotive or other vehicle, such as painting the locomotive or other vehicle, replacing fluids of the locomotive or other vehicle, cleaning the locomotive or other vehicle, and the like.

The ADS may store the work requirements for the different assets, such as in a project requirements database system (PRDS) 340 that includes at least one database 345. Optionally, the PRDS may represent the IRDS 140 shown in FIG. 1 and the database 345 may represent the database 145 shown in FIG. 1. The PRDS includes the work requirements from which the sets of tasks to be performed on the assets are generated. The system 300 also includes the WDS 130 and database 135 described above. In embodiments, the ADS, PRDS, IRDS, and/or WDS may be implemented in a single database system or implemented in two or more database systems as desired.

The ADS, IRDS, PRDS, and/or the WDS communicate with each other and/or the scheduling system 150 via the computer network to generate a schedule to tasks to be performed on one or more of the assets, as described above. The controller can create the schedule of tasks to be performed, and these tasks can include inspection tasks (to inspect an asset), repair tasks to repair one or more components of an asset), maintenance tasks (to maintain the asset and delay degradation of the asset), preparation tasks (to get the asset ready for an upcoming mission), or the like.

The scheduled tasks are performed by one or more workforce personnel 302, such as employees, contractors, or any other personnel, and associated tools and equipment. The workforce personnel may have electronic workforce devices 304 that are used to convey information from the personnel to the controller of the scheduling system, and/or from the controller to the personnel. The workforce devices may be computer devices having hardware circuits or circuitry that include and/or are connected with one or more computer microprocessors, such as a mobile phone, tablet computer, transponder, electronic beacon, radio frequency identification (RFID) tag, or the like. Optionally, the workforce device can include another device or system, such as one or more cameras, sensors (e.g., touch sensitive sensors on the floor that detect movements), RFID readers, or the like. The workforce devices can be used to receive information input by the workforce personnel, to communicate information to the workforce personnel (e.g., from the controller of the scheduling system), to monitor locations of the workforce personnel, or the like.

Electronic asset devices 308 may be connected with or otherwise disposed near the assets. The asset devices can be used to convey information from the assets to the controller of the scheduling system, and/or from the controller to the assets. The asset devices may be computer devices having hardware circuits or circuitry that include and/or are connected with one or more computer microprocessors, such as a mobile phone, tablet computer, transponder, electronic beacon, RFID tag, or the like. Optionally, the asset device can include another device or system, such as one or more cameras, sensors (e.g., touch sensitive sensors on the floor that detect movements), RFID readers, or the like. The asset devices can be used to receive information input by the assets, to communicate information to the assets (e.g., from the controller of the scheduling system), to monitor locations of the assets, or the like.

In one aspect of the inventive subject matter described herein, the controller of the scheduling system may generate the schedule of tasks to be performed on an asset based on the location of workforce personnel and/or the location of the asset. For example, the controller may identify where the asset is currently located, and determine the expertise of the workforce personnel needed to perform the scheduled tasks on the asset. The expertise of the workforce personnel may be stored as the workforce information described above. Optionally, constraints on the workforce personnel may be stored, as described herein. The controller may select those personnel that have the appropriate expertise (e.g., an area of expertise that is needed to perform one or more of the scheduled tasks, such as an electrician needed for electrical repairs, a fluid mechanic needed for repairs to a pneumatic system, or the like), that are available to perform the tasks at the schedule time(s), that are located closer to the asset than one or more other, or all, other personnel, personnel that are allowed to work on various tasks, personnel that have the appropriate certifications to perform the work, and the like.

Optionally, the controller may communicate notification signals to one or more workforce devices to notify the personnel with the workforce devices of the location of the asset to be worked on, as well as the locations of workforce personnel (e.g., persons and/or equipment) have the availability and/or expertise to perform the scheduled tasks for the asset.

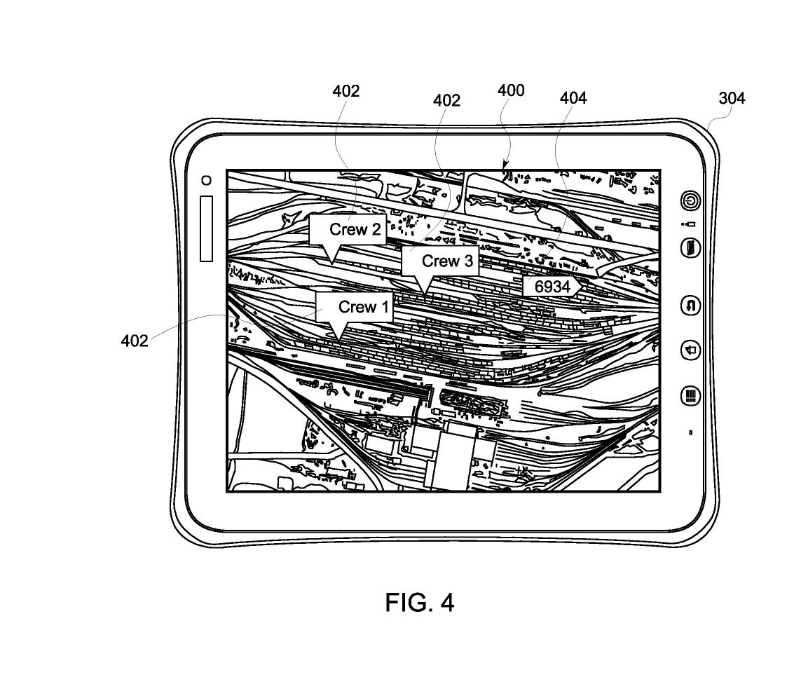

FIG. 4 illustrates one example of the workforce device 304 shown in FIG. 3. In the illustrated example, the workforce device is a tablet computer, but optionally may be a mobile phone, desktop computer, or other device. The workforce device 304 can receive notification signals from the controller of the scheduling system that notify the workforce device of locations of workforce personnel and the asset on which the scheduled tasks are to be performed. Based on these notification signals, the workforce device can visually present a map 400 or other spatial representation having workforce indicators 402 and asset indicators 404. The workforce indicators represent locations of workforce personnel (e.g., as reported or detected from the workforce devices associated with or carried by the workforce personnel) and the asset indicators represent locations of the assets on which the scheduled tasks are to be performed. Optionally, the workforce indicators can represent the locations of equipment or other tools used in the performance of the scheduled tasks.

The map 400 (or a similar presentation) shown on the workforce device can be used by one or more of the workforce personnel to select the asset on which to perform the scheduled tasks. For example, the locations of three groups, or crews, of workforce personnel are shown in the map 400. These crews may be selected by the controller for being shown on the workforce device due to these crews including workforce personnel having the areas of expertise needed to perform the scheduled tasks and/or being closer to the asset than one or more other crews. In one aspect, the presentation can be shown on the workforce devices of one or more workforce personnel in each crew. The workforce personnel of at least one of the crews who view the map 400 can then select (using a workforce device) the asset indicator (or otherwise provide input to the workforce device) to indicate that that crew will perform at least some, or all, of the scheduled tasks. A responsive signal is sent from the workforce device to the controller in order for the controller to know which of the workforce personnel is to perform the scheduled tasks. In doing so, the controller can find and identify workforce personnel that are available to perform scheduled tasks on an asset, that are closer to the asset than one or more other workforce personnel, and/or that are available to perform the scheduled tasks.

Optionally, the map 400 (or a similar presentation) can be displayed on the workforce device of a manager or supervisory personnel that manages or supervises other workforce personnel. The manager or supervisory personnel can then select which of the workforce personnel (e.g., crew 1, crew 2, or crew 3 in FIG. 4) is to go to the asset and perform the scheduled tasks. The manager or supervisory personnel can touch (where the workforce device includes a touchscreen) or otherwise input into the workforce device which of the workforce personnel is selected to perform the scheduled tasks, and the workforce device can communicate a responsive signal to the controller. This signal can indicate which of the workforce personnel is selected to perform the scheduled tasks. Instructional signals can be sent by the controller to the workforce devices of the selected workforce personnel to notify the personnel that they have been selected to perform the scheduled tasks and/or the location of the asset.

In one aspect of the inventive subject matter described herein, the controller of the scheduling system can monitor the workforce personnel needed to complete the scheduled tasks on one or more assets, and can determine an amount of available workforce personnel that can complete the scheduled tasks on the assets within a designated time period. For example, for a scheduled set of tasks that requires the expertise of three electricians and four mechanical engineers, the scheduling system can determine, based on information stored in the WDS, if at least three electricians and four mechanical engineers are available during a current or upcoming work shift (e.g., an eight hour time period or other time period) to perform the scheduled set of tasks. For example, from the workforce constraints stored in the WDS, the controller can determine which workforce personnel are available to perform the scheduled set of tasks.

Based on the available workforce personnel that can perform the scheduled sets of tasks on one or more assets subject to the workforce constraints and the workforce personnel needed to complete the scheduled sets of tasks, the controller can calculate a labor shortfall for completing the scheduled sets of tasks within a designated time period (e.g., a work day, eight hour shift, or the like). The labor shortfall is a quantifiable measurement of how much additional workforce personnel is needed to complete the scheduled sets of tasks on the assets within the designated time period. As described above, some workforce restrictions can limit how long one or more of the workforce personnel can work on the tasks. These restrictions, and the unavailability of the workforce personnel currently working on other tasks, can cause the needed workforce personnel to exceed the available workforce personnel. The labor shortfall can represent a difference in terms of persons, available hours to work (or other unit of time), and the like, between the workforce personnel needed to complete the scheduled tasks and the available workforce personnel.

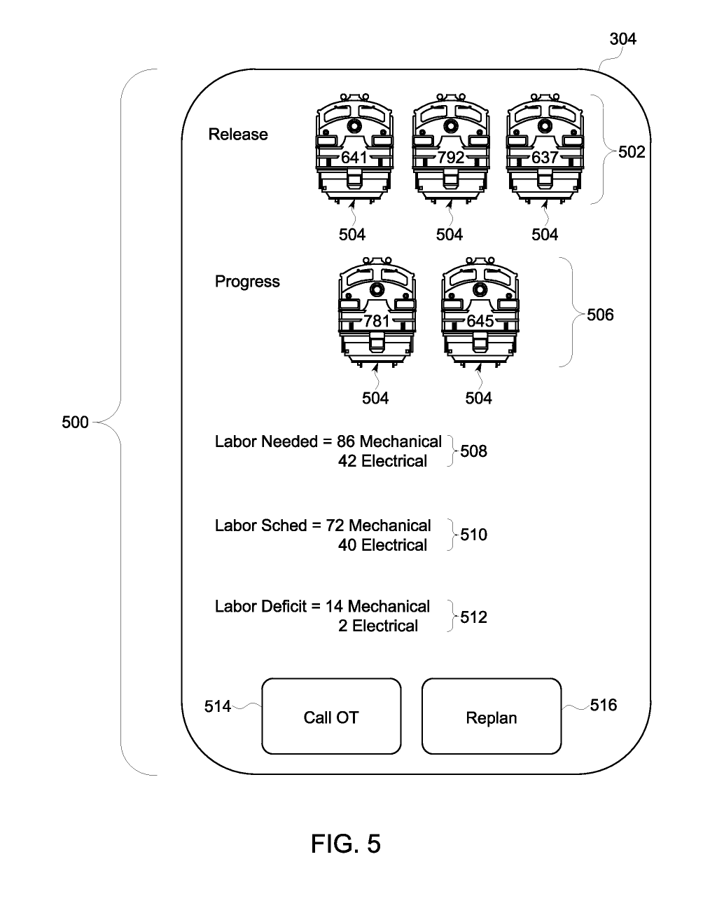

FIG. 5 illustrates one example of a status presentation 500 that can be visually presented on one or more of the workforce devices 304 shown in FIG. 3 according to one aspect of the inventive subject matter described herein. The status presentation may be shown to one or more of the workforce personnel to allow those workforce personnel to more easily identify and remediate any labor shortfalls. The status presentation can be used by a manager or supervisor to check on the status of the scheduled tasks for one or more assets, identify labor shortfalls, obtain additional workforce personnel to perform the tasks, and the like. The information presented on the workforce device 304 can be determined by the controller of the scheduling system and/or one or more other components of the system 100, and communicated to the workforce device 304 for presentation to a user of the workforce device.

The status presentation 500 includes a release portion 502 that indicates assets for which the scheduled set of tasks is completed. This release portion of the example presentation in FIG. 5 includes asset icons 504 that represent different assets. The scheduled sets of tasks for the assets represented by the asset indicators have been completed, and these assets are ready for use to perform missions. The controller can determine the statuses of the scheduled sets of tasks based on information received from the workforce devices. For example, during performance of the scheduled sets of tasks, the workforce personnel can provide to the controller, via the workforce devices, when various tasks are completed. Based on this information, the controller can determine when the scheduled set of tasks for an asset has been completed. The status presentation 500 also can include a progress portion 506 that indicates assets for which the scheduled set of tasks is still being performed. This progress portion of the presentation also includes asset icons 504. The scheduled sets of tasks for the assets represented by the asset indicators are still being performed, and these assets are not yet ready for use to perform missions.

A workforce required portion 508 of the presentation 500 indicates the workforce personnel needed to perform one or more scheduled sets of the tasks. In the illustrated example, the workforce required portion 508 represents the number of working hours that are estimated by the scheduling system to be needed to complete the scheduled sets of tasks for the assets within a designated time period (e.g., within the next 24 hours, within the next 8 hours, or another designated time period or limit). For example, 86 hours of work are estimated to be needed from workforce personnel having expertise in mechanical engineering or mechanical arts and 42 hours of work are estimated to be needed from workforce personnel having expertise in electrical engineering or electrical arts in order to complete the scheduled sets of tasks during the next 24 hours. The estimated hours of work that are needed can be calculated by the controller based on identification of the tasks that are included in the scheduled sets of tasks and designated time periods for those tasks. For example, if a first task is associated with a designated completion time period of two working hours from a mechanical engineer and one working hour from an electrical engineer, then each time a scheduled set of tasks includes the first task, the controller estimates that, in addition to other tasks included in the scheduled set, the first task adds two working hours for a mechanical engineer and one working hour from an electrical engineer. The workforce required portion 508 of the presentation 500 may represent a sum total, average, or other measurement of the working hours that are estimated to be needed to complete the scheduled set of tasks that are scheduled to be completed within the designated time period (e.g., 24 hours or another length of time). The workforce required portion 508 can represent a moving window of time such that the total working hours needed changes as time proceeds, with the total working hours representing how many working hours are needed within the next designated time period. Optionally, the workforce required portion 508 can represent another estimated measurement of the work needed during the upcoming time period, such as a total number of workforce personnel, equipment, tools, or the like.

A workforce available portion 510 of the presentation 500 indicates the workforce personnel that are available to perform at least some of the scheduled sets of tasks during the upcoming designated time period (e.g., the next 24 hours). In the illustrated example, the workforce scheduled portion 510 represents the number of working hours that is available from the workforce personnel within the upcoming designated time period. For example, 72 hours of work are available from workforce personnel having expertise in mechanical engineering or mechanical arts and 40 hours of work are available from workforce personnel having expertise in electrical engineering or electrical arts in order to complete the scheduled sets of tasks during the next designated time period. Alternatively, the workforce scheduled portion 510 can represent the number of workforce personnel, equipment, tools, or the like, that are available.

The controller of the scheduling system may calculate the available workforce personnel based on workforce constraints, schedules of the workforce personnel, and the like, that are stored in the database of the WDS. For example, based on the number of workforce personnel that are scheduled to be at work during the next designated time period, the expertise of this personnel, the workforce constraints that limit how long these personnel can work on the scheduled sets of tasks, limitations on how many different sets of tasks that the personnel can work on at a given time, limitations on the types of tasks that the personnel can and cannot perform, availability of tools, equipment, facilities, etc., to perform the tasks, and the like, the controller can calculate the available workforce personnel for the upcoming designated time period. The workforce available portion 510 can represent a moving window of time such that the total available working hours changes as time proceeds, with the total available working hours representing how many working hours are available from the workforce personnel within the next designated time period. Optionally, the workforce available portion 510 can represent another estimated measurement of the work available during the upcoming time period, such as a total number of workforce personnel, equipment, tools, or the like.

A labor shortage portion 512 of the presentation 500 represents a difference between the total available work and the total needed work during the upcoming designated time period. For example, in the illustrated example, 14 more working hours or personnel are needed in the mechanical art than are available during the upcoming time period and two more working hours or personnel are needed in the electrical art than are available during the upcoming time period. The controller may calculate these labor shortages by determining a difference between the available workforce personnel and the needed workforce personnel. As shown in the example of FIG. 5, more labor is needed than is available from the workforce personnel to complete the scheduled set of tasks in the upcoming designated time period.

The controller of the scheduling system can provide the workforce personnel using the device 304 (e.g., a manager, supervisor, or the like) with options for remediating such a labor shortage. In one aspect, the controller can direct the workforce device to present the user of the device with an option for automatically approving or requesting additional working hours and/or personnel to at least partially make up for the labor shortage. For example, the controller can direct the workforce device to graphically display a first input button 514 (e.g., “Call OT,” or call overtime, in FIG. 5) on the workforce device. Alternatively, the button 514 may be replaced with another way for the user of the workforce device to provide input that requests additional labor. For example, the workforce device can receive input that requests or approves additional labor from workforce personnel via a keyboard, stylus, microphone, or the like.

In one example, responsive to identifying the labor shortfall, a user of the workforce device (e.g., a supervisor or manager) can actuate the first input button to automatically approve one or more workforce personnel to work in excess of one or more workplace restrictions. Some workforce personnel may be preapproved to work in excess of a limitation on the amount or number of hours within a given time period (e.g., day, week, month, year, etc.). For example, some workforce personnel may communicate to the controller of the scheduling system (e.g., via the workforce devices) which days, weeks, months, or the like, that the workforce personnel is interested in or willing to work longer than a soft workforce constraint. These communications from the workforce personnel may be automatically and/or manually reviewed, such as by comparing the requests for additional work from the workforce personnel to budgets, hard workforce constraints, or the like. Some of the workforce personnel may be approved for the additional work in excess of the soft workforce constraints. Identities of these personnel, their areas of expertise, the details on when the personnel can work in excess of the soft workforce constraints, or other information, can be stored in the database 135 of the WDS as workforce information.

When the supervisor or manager requests the additional labor to meet or exceed the labor shortfall identified by the controller (e.g., by actuating the first button on the workforce device), the controller may receive the request from the workforce device and examine the workforce information of the WDS to identify one or more workforce personnel who can provide additional labor to meet or exceed the labor shortfall. For example, if additional hours are needed from personnel having mechanical expertise (or another area of expertise), then the controller of the scheduling system can identify, from the workforce information, one or more of the workforce personnel who have mechanical expertise and who have requested and/or been approved for additional work. In one aspect, the controller may then communicate notifications to these previously approved workforce personnel (e.g., calls, texts, emails, or the like, to mobile phones, home phones, work phones, tablet computers, or other workforce devices) instructing them to provide the additional work. The controller additionally request confirmation from the previously approved workforce personnel to determine whether or not these personnel will accept the request for the additional labor. If the previously approved workforce personnel accept the request, then the controller can communicate a notification to the workforce device of the supervisor, manager, or other personnel to inform of the amount or number of additional workforce personnel that will be assisting to reduce the labor shortfall. In one aspect, the controller may communicate signals only those workforce personnel that previously agreed to the additional work (e.g., overtime) and/or that have been approved to do the additional work, and not to other workforce personnel who have not so agreed or have not been approved.

Optionally, the controller of the scheduling system may direct the workforce device to notify the supervisor, manager, or other person of efficiencies of different personnel in completing scheduled tasks. For example, the database 135 in the WDS 130 can store historical data representative of how long it took different workforce personnel to complete various tasks. When one or more of these personnel are identified by the controller for potentially working the additional time requested, the controller may direct the workforce device to inform the supervisor, manager, or other person of how long it has taken the various personnel to perform the scheduled tasks. The supervisor, manager, or other person may then select from among these personnel those persons that are more efficient at completing the tasks in order to reduce any additional costs associated with the additional work (e.g., to reduce the amount of overtime).

The controller of the scheduling system can optionally direct the workforce device of the supervisor, manager, or other person to present an option for automatically rescheduling the scheduled tasks for one or more assets in order to reduce or eliminate the labor shortfall. For example, the controller may generate schedules of tasks for the assets, with the schedules including a first order in which the tasks are to be completed for the assets. Responsive to a labor shortfall being identified, the controller can direct the workforce device to graphically display a second input button 516 (e.g., “Replan” in FIG. 5) on the workforce device. Alternatively, the button 516 may be replaced with another way for the user of the workforce device to provide input that requests rescheduling of tasks. For example, the workforce device can receive input that reschedules tasks from workforce personnel via a keyboard, stylus, microphone, or the like.

In response to a user providing input into the workforce device that requests rescheduling of tasks, the controller receives a request signal from the workforce device. The controller may then examine the scheduled tasks to determine if the order of the tasks can be modified to reduce or eliminate the labor shortfall. A first order of the tasks for one or more assets may require workforce personnel to work longer on certain tasks than a different, second order of the tasks. Additionally, restrictions on which tasks are performed after other tasks may prevent changing at least part of the scheduled order of the tasks.

The controller of the scheduling system may change the scheduled order of the tasks in an attempt to reduce the total time needed to complete the scheduled tasks for one or more assets and/or to reduce the total time that one or more workforce personnel are needed to be working on the scheduled tasks for one or more assets. Reducing the total time needed to complete the tasks can reduce the labor shortfall for the upcoming designated time periods. Reducing the total time that workforce personnel is needed can free up that personnel to work on the scheduled tasks of other assets, and also reduce the labor shortfall for the upcoming designated time period.

Optionally, the controller of the scheduling system may change the scheduled order of the tasks, may request additional workforce personnel (e.g., in excess of restrictions, as described above), or the like, to complete more tasks within a designated time period. For example, a first number of tasks may be scheduled for completion during a designated time period (e.g., 24 hours or another length of time). An operator may use the scheduling system to approve and/or request additional workforce personnel (based on constraints, expertise, availability, pre-approval of excess working time, and the like, as described herein) and/or change the order in which the tasks are completed in order to complete a greater, second number of tasks within the same designated time period.

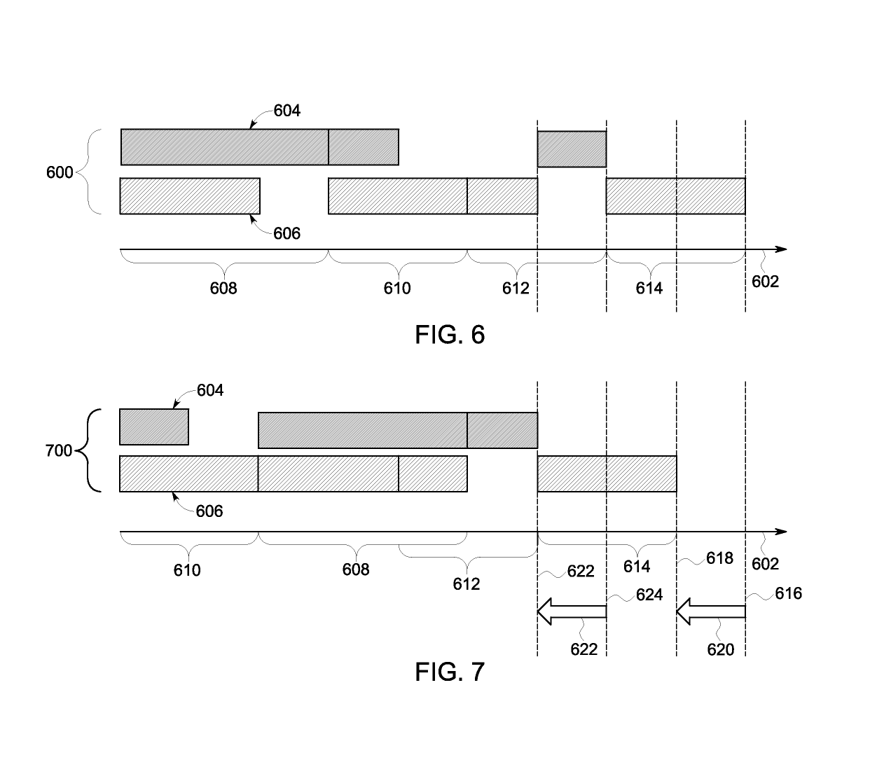

FIGS. 6 and 7 illustrate timeline representations 600, 700 of a same set of tasks scheduled in different orders according to one example of the inventive subject matter described herein. The timeline representations 600, 700 are shown alongside a horizontal axis 602 representative of time. The timeline representations 600, 700 include time blocks 604, 606 (e.g., time blocks 604a-d and 606a-d) representative of designated time periods that different workforce personnel are scheduled to work on various tasks. For example, the time blocks 604 represent the designated time periods over which workforce personnel having a mechanical area of expertise or being certified in a certain technology are expected to be working on different tasks 608, 610, 612, 614 and the time blocks 606 represent the designated time periods over which workforce personnel having an electrical area of expertise are expected to be working on the tasks 608, 610, 612, 614. The horizontal length of the time blocks 604, 606 represents how long the associated task is expected to take to complete for the corresponding workforce personnel. These expected lengths of time may be designated completion time periods, such as time periods established by a supervisor, manager, industry standard, company standard, a historical analysis of previous completions of the tasks, or the like.

The timeline representation 600 illustrates a first scheduled order of the tasks in which there is a labor shortfall. As shown, the first task 608 is scheduled to be completed first, followed by the second task 610, the third task 612, and then the fourth task 614. Limitations on the order of the tasks may prevent some tasks from being performed before or after other tasks when the controller attempts to reschedule the tasks. Due to restrictions on the order of the tasks, the fourth task 614 may be required to be performed after the third task 612 and/or the third task 612 may be required to be performed after the first task 608.

In the illustrated example, scheduling of the tasks according to the first order shown in the timeline representation results in the tasks being scheduled to be completed at a first time 616 (shown in FIG. 7). The controller can re-order the schedule of tasks so that the second task 610 is scheduled first and at least part of the third task 612 is scheduled to occur concurrently with the first task 608. As a result, the rescheduled order of tasks shown in the timeline representation 700 is scheduled to be completed at an earlier second time 618 (shown in FIG. 7). A time savings 620 shown in FIG. 7 indicates how much sooner the rescheduled set of tasks is to be completed with the rescheduling. This rescheduling can reduce the labor shortfall, such as by completing the scheduled tasks earlier in order to free up at least some workforce personnel to work on other tasks, by completing the tasks within the upcoming designated time period (e.g., the next 24 hours, work shift, or other time period), or the like. As shown in the timeline representations 600, 700, the workforce personnel scheduled to perform the work represented by the time blocks 604 is scheduled to be done with the tasks at an earlier third time 622 in the rescheduled order (e.g., the timeline representation 700) than a later fourth time 624 in the previous order (e.g., the timeline representation 600). As a result, this workforce personnel is scheduled to be available to assist on other assets by at least a time savings 624. Similarly, the other workforce personnel (e.g., that performs the work represented by the time blocks 606) may be completed earlier by at least the time savings 620.

Returning to the description of the presentation 500 displayed on a workforce device in FIG. 5, the controller of the scheduling system can reschedule the tasks for one or more assets responsive to receiving input from the workforce device. As a result, more of the sets of tasks may be completed earlier and/or more workforce personnel may be available at an earlier time to assist with other assets. Consequently, the labor shortfall can be reduced and/or eliminated.

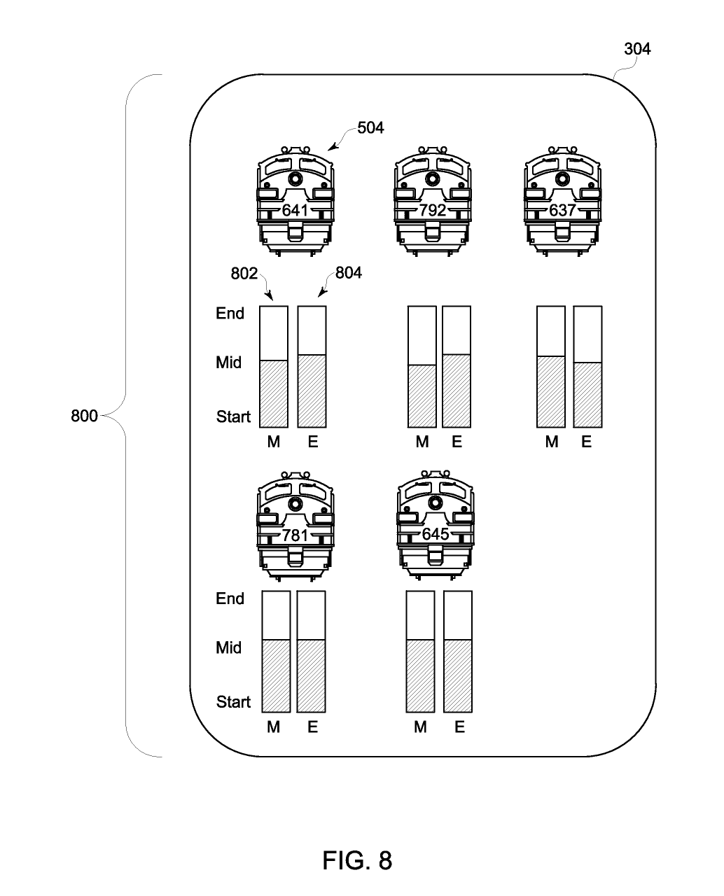

FIG. 8 illustrates another example of a status presentation 800 that can be visually presented on one or more of the workforce devices 304 shown in FIG. 3 according to one aspect of the inventive subject matter described herein. The status presentation may be shown to one or more of the workforce personnel to allow those workforce personnel to more easily check on the status of scheduled sets of tasks being performed on one or more assets.

In one aspect, the user of the workforce device can provide input to the device (e.g., through touch of a touchscreen, use of a stylus, verbal instructions, use of a keyboard, or the like) to select the presentation shown in FIG. 8. Similar to the presentation of the workforce device shown in FIG. 5, the presentation of FIG. 8 includes several asset icons 504 that represent various assets on which sets of tasks have been performed, are scheduled to be performed, and/or are currently being performed. Progress gauges 802, 804 are displayed in locations near the asset icons. The progress gauges represent how far the workforce personnel have progressed in completing the scheduled sets of tasks for the assets represented by the asset icons shown near the progress gauges.

The progress gauges 802 can represent how far completion of the scheduled set of tasks that involve or are performed by workforce personnel having a first area of expertise (e.g., a mechanical area of expertise) has progressed. Other progress gauges 804 can represent how far completion of the scheduled set of tasks for another, second area of expertise (e.g., an electrical area of expertise) has progressed. While only two progress gauges 802, 804 are shown for each asset icon, optionally, a smaller or greater number of progress gauges may be shown. In the illustrated example, the asset icons are shown with identification numbers associated with the different assets. The progress gauges may fill up or otherwise represent the fraction, percentage, proportion, or the like, of the scheduled sets of tasks that are completed.

For example, for the asset icon representing the “641” asset, the progress gauges indicate that the mechanical and electrical tasks (e.g., the tasks performed by workforce personnel with mechanical experience and the tasks performed by workforce personnel with electrical experience) are approximately 50% or halfway completed. The progress gauges for other assets indicate similar progress. Optionally, one or more of the progress gauges may be more or less filled to indicate more of the scheduled set of tasks being completed or less of the scheduled set of tasks being completed for that asset, respectively.

In one aspect, the progress gauges can indicate an alarm state for progress of the scheduled set of tasks for an asset. For example, if work on the scheduled set of tasks for an asset is interrupted or stopped for an unscheduled reason (e.g., discovered damage to the asset, needed repair on the asset, depletion of material needed to complete a task, injury to workforce personnel, or the like), then the progress gauge that represents those tasks can indicate the interruption or stoppage. The progress gauge can change color (e.g., from green to red), flash, or otherwise visually notify the user of the alarm state for the corresponding asset. Optionally, the alarm state can be shown by the progress gauges when progress of the scheduled set of tasks is behind schedule.

The workforce device may be aware of the stoppage of work, interruption of work, falling behind schedule, or the like, to change the progress gauge based on signals received from the controller of the scheduling system. As tasks in a scheduled set are completed, the controller may be notified by signals received from the workforce devices used by workforce personnel performing the tasks, from sensors disposed at or near the assets, or may be notified in another manner. The controller may compare when the tasks actually are completed to designated completion times associated with the tasks. When the time periods in which the tasks actually are completed fall behind the designated completion times (and/or when progress of completing the tasks falls behind the scheduled rate at which the tasks are to be completed), then the controller may communicate an alarm signal to the workforce device. The workforce device may then use the progress gauge to indicate the tasks falling behind schedule and a user of the workforce device can easily track the progress of the tasks and determine any alarm states of the tasks.

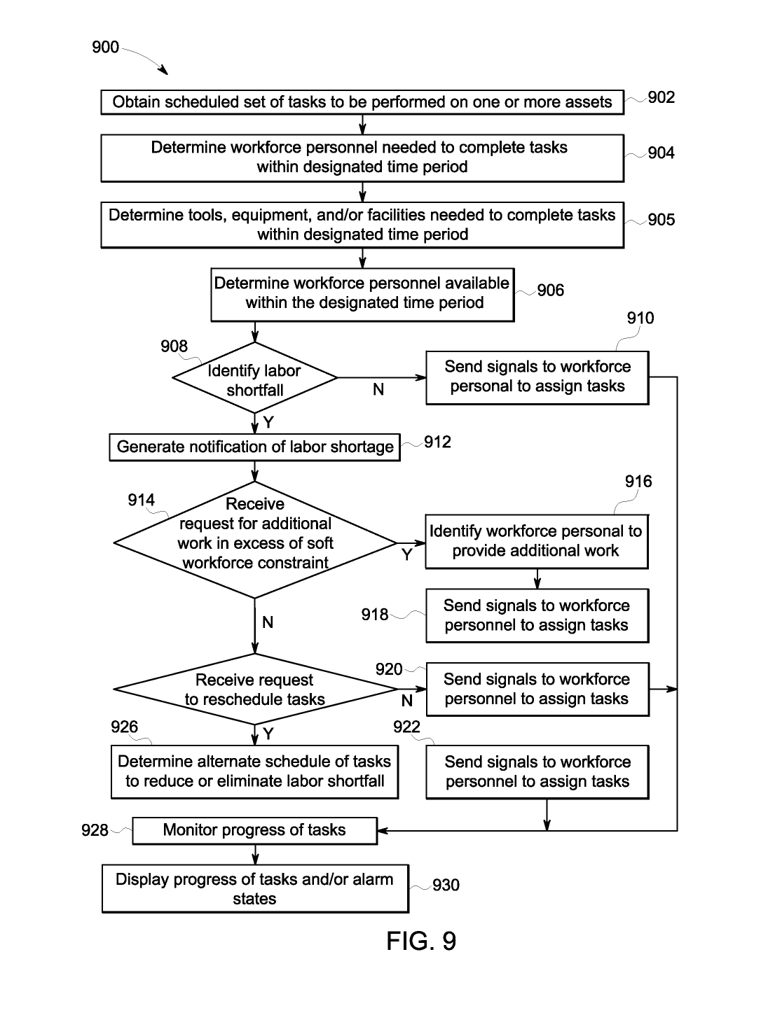

FIG. 9 is a flowchart of a method 900 for monitoring and/or scheduling a workforce according to one example of the inventive subject matter described herein. The method can be performed by one or more of the systems and devices described herein. At 902, one or more scheduled sets of tasks to be performed on one or more assets are obtained. The sets of tasks may be used to inspect, maintain, repair, and/or prepare the assets. The sets of tasks may be scheduled by the controller of the scheduling system, as described above.

At 904, the workforce personnel needed to complete the scheduled sets of tasks within a designated time period is determined. For example, the number of workers, hours of work, or other measurement of how much personnel is needed to complete the tasks is determined. This amount may be determined for an upcoming designated time period, such as within the next work shift (e.g., eight hours), the next day (e.g., 24 hours), or another length of time. The scheduled tasks may be associated with a designated amount of workforce personnel (e.g., in terms of persons, hours of work, or the like) so that the total workforce personnel needed to complete the tasks can be estimated or calculated.

At 905, the availabilities of tools, equipment, and/or facilities that are used to perform the scheduled tasks are determined. For example, if a specialized tool or equipment is needed to complete a scheduled task, or a particular facility is needed for a location to complete the scheduled task, then the availability or lack of availability of the tool, equipment, and/or facility to complete the tasks may be determined. Because multiple tasks may require the use of the same tools, equipment, and/or facilities, some tools, equipment, and/or facilities may not be available or the time periods over which the tools, equipment, and/or facilities are available may be limited. These limitations on the tools, equipment, and/or facilities may be identified, such as from the DB 175 of the EDS 170, or from another location.

At 906, the workforce personnel that are available to complete the scheduled sets of tasks are determined. For example, the workforce personnel that are scheduled to be at work and/or that actually are at work, the upcoming length of time that the workforce personnel are available to work within the upcoming designated time period, the areas of expertise (e.g., skills) of the workforce personnel, and the like, are examined to determine the number of persons, hours of work, or the like, that can be provided in the upcoming designated time period.

At 908, a comparison is made between the workforce personnel needed to complete the scheduled sets of tasks within the upcoming designated time period, the available workforce personnel, and/or the available tools, equipment, and/or facilities to determine if a labor shortfall exists. If the available workforce personnel and/or available tools, equipment, and/or facilities meet or exceed the needed workforce personnel, tools, equipment, and/or facilities, then the current workforce personnel and available tools, equipment, and/or equipment may be able to complete the scheduled sets of tasks within the upcoming designated time period. As a result, flow of the method can proceed to 910.

At 910, communication signals are sent to the available workforce personnel to notify the workforce personnel of the scheduled sets of tasks. For example, the workforce devices of the workforce personnel may receive messages from the controller of the scheduling system that assign the tasks to different ones of the workforce personnel. The workforce personnel may then begin work on the sets of tasks that have been scheduled.

On the other hand, at 908, if more workforce personnel, tools, equipment, and/or facilities are needed to complete the scheduled sets of tasks than is available in the upcoming designated time period, then a labor shortage or shortfall is identified. As a result, more workforce personnel may be needed and/or the order in which the tasks are scheduled may need to be modified to reduce or eliminate the labor shortage. Flow of the method may then proceed to 912.

At 912, a notification of the labor shortage is generated. For example, the controller of the scheduling system can communicate a signal to the workforce device of one or more workforce personnel (e.g., a manager, supervisor, or other person). This signal can notify this person of the labor shortage. As described above, in one aspect, the amount of the labor shortage can be visually presented (or otherwise output) to the workforce device so that the user of the device can determine the severity of the labor shortage.

At 914, a determination is made as to whether a request is received to request additional workforce personnel. As described above, workforce constraints can limit how much the workforce personnel are allowed to work during various time periods. Some of these constraints can be soft constraints that can be exceeded. For example, a contractual or other limitation on the number of hours that an employee works can be exceeded by approving the employee for overtime work. One or more persons (e.g., a supervisor, manager, or the like) can provide input into his or her workforce device a request for additional workforce personnel. This request can be for workforce personnel to work overtime, for additional workforce personnel that are not currently working to come into work, or the like.

If such a request is received (e.g., by the controller of the scheduling system), then flow of the method can proceed to 916. At 916, the workforce personnel needed to reduce or eliminate the labor shortage are identified. For example, the controller of the scheduling system can examine the areas of expertise that are needed to complete the tasks that are associated with the labor shortage, the areas of expertise of those personnel that have requested and/or been approved for working in excess of workforce constraints, and the like, to determine which workforce personnel should be assigned to assist with the scheduled sets of tasks to reduce or eliminate the labor shortage.

At 918, communication signals are sent to those workforce personnel identified at 916. For example, the controller of the scheduling system can communicate signals to the workforce devices of the identified workforce personnel. These signals may instruct the workforce personnel that the workforce personnel are to assist on the scheduled sets of tasks. The workforce personnel may then begin working on the scheduled sets of tasks.

On the other hand, at 914, if a request for additional workforce personnel is not received by the controller of the scheduling system, then the workforce personnel may not be requested to work in excess of soft workforce constraints (e.g., the supervisor or manager does not want to use overtime to complete the scheduled sets of tasks). As a result, flow of the method can proceed to 924.

At 924, a determination is made as to whether a request is received to reschedule one or more of the sets of tasks. As described above, changing the order in which the tasks are scheduled in one or more of the sets of tasks. Can reduce the time needed to complete the tasks and thereby reduce or eliminate the labor shortage identified at 908. The request may be made by a workforce personnel (e.g., manager or supervisor) providing input into a workforce device. The controller of the scheduling system determines if the controller receives such a request. If a request to reschedule is received, then flow of the method may continue to 926. If no such request is received, then flow of the method can proceed to 920.

At 926, one or more alternate schedules of the tasks are determined. For example, the controller may change the order in which the tasks are ordered in the previously scheduled sets of tasks. The order of some of the tasks may be restricted (e.g., a first task may need to be completed before work on a second task is begun), and the controller may generate the alternate schedules of the tasks subject to any such restrictions. The estimated times to complete the alternate schedules of the tasks are calculated and may be compared with each other to determine which, if any, have estimated completion times that are shorter than the previous scheduled sets of tasks and/or one or more other alternate schedules of the tasks. One or more of the alternate schedules are selected so that the estimated labor shortage is reduced or eliminated.

At 922, communication signals are sent to the workforce personnel (e.g., to the workforce devices of the personnel) to notify the workforce personnel of the alternate schedules of the tasks. For example, the tasks to which one or more of the workforce personnel were assigned may have changed. The tasks to which these personnel are now assigned according to the alternate schedules may be communicated to the personnel.

At 928, progress of the work being performed by the workforce personnel on the tasks is monitored. The workforce personnel may provide input into the workforce devices to update the controller of the scheduling system of the progress in completing the tasks. Optionally, one or more sensors, cameras, or the like, may be used to monitor progress of the tasks.

At 930, the progress of the tasks and/or alarm states may be displayed on one or more of the workforce devices, as described above. This display may allow a supervisor, manager, or other employee to track the progress of the tasks performed on several assets at the same time, and/or to quickly identify problems with the progression of completing the tasks.

In one example of the inventive subject matter described herein, a method (e.g., for monitoring and/or scheduling a workforce) includes calculating, with one or more computer processors, a labor shortfall for completion of a set of tasks within a designated time period. The labor shortfall represents a difference between an amount of required workforce personnel that is needed to complete the set of tasks within the designated time period and an amount of available workforce personnel during the designated time period. The available workforce personnel are subject to one or more workforce constraints on how long the available workforce personnel can work within the designated time period. The method also includes visually presenting, with the one or more computer processors on an electronic device of an operator, an indication of the labor shortfall, and responsive to receiving first operator input on the electronic device of the operator, automatically generating one or more communication signals that are sent to one or more mobile devices of at least one of the available workforce personnel or additional workforce personnel. The one or more communication signals request additional work on the set of tasks by the at least one of the available workforce personnel or the additional workforce personnel in excess of the one or more workforce constraints.

In one aspect, the method also includes determining a first order in which the tasks are to be completed within the designated time period, where the labor shortfall is calculated based on the first order in which the tasks are to be completed. The method may further include, responsive to receiving second operator input on the electronic device of the operator, determining a different, second order in which the tasks are to be completed. The set of tasks cannot be completed within the designated time period with the available workforce personnel when completed in the first order but can be completed within the designated time period with the available workforce personnel when completed in the second order.

In one aspect, the one or more workforce constraints include contractual limitations on working hours of the available workforce personnel.

In one aspect, the method also can include determining which of the at least one of the available workforce personnel or additional workforce personnel has previously agreed to work additional hours prior to calculating the labor shortfall and selecting the at least one of the available workforce personnel or additional workforce personnel that has previously agreed to work the additional hours for receiving the one or more communication signals.

In one aspect, the one or more communication signals are only sent to the at least one of the available workforce personnel or additional workforce personnel that has previously agreed to work the additional hours and are not sent to the at least one of the available workforce personnel or additional workforce personnel that have not previously agreed to work the additional hours.

In one aspect, the method also includes determining which of the at least one of the available workforce personnel or additional workforce personnel has been previously approved to work additional hours by a third person prior to calculating the labor shortfall and selecting the at least one of the available workforce personnel or additional workforce personnel that has been previously approved to work the additional hours for receiving the one or more communication signals.

In one aspect, the one or more communication signals are only sent to the at least one of the available workforce personnel or additional workforce personnel that has been previously approved to work the additional hours and are not sent to the at least one of the available workforce personnel or additional workforce personnel that have not been previously approved to work the additional hours.

In one aspect, the method also includes displaying, on the electronic device of the operator, one or more visual indicia representative of at least one of progress or problems with the set of tasks during work on the set of tasks.

In another example of the inventive subject matter described herein, a system (e.g., for scheduling and/or monitoring a workforce) includes a controller (having one or more computer processors) that is configured to identify a labor shortfall for completion of a set of tasks within a designated time period. The labor shortfall represents a difference between an amount of required workforce personnel that is needed to complete the set of tasks within the designated time period and an amount of available workforce personnel during the designated time period, the available workforce personnel subject to one or more workforce constraints on how long the available workforce personnel can work within the designated time period. The controller also is configured to direct an electronic device of an operator to visually present an indication of the labor shortfall, and to receive first operator input via the electronic device of the operator and, responsive to receiving the first operator input. The controller is further configured to automatically generate one or more communication signals that are sent to one or more mobile devices of at least one of the available workforce personnel or additional workforce personnel. The one or more communication signals request additional work on the set of tasks by the at least one of the available workforce personnel or the additional workforce personnel in excess of the one or more workforce constraints.

In one aspect, the controller also is configured to determine a first order in which the tasks are to be completed within the designated time period. The labor shortfall is calculated based on this first order in which the tasks are to be completed. The controller can be configured to, responsive to receiving second operator input on the electronic device of the operator, determine a different, second order in which the tasks are to be completed. The set of tasks cannot be completed within the designated time period with the available workforce personnel when completed in the first order but can be completed within the designated time period with the available workforce personnel when completed in the second order.

In one aspect, the one or more workforce constraints include contractual limitations on working hours of the available workforce personnel.

In one aspect, the controller is configured to determine which of the at least one of the available workforce personnel or additional workforce personnel has previously agreed to work additional hours prior to calculating the labor shortfall. The controller also configured to select the at least one of the available workforce personnel or additional workforce personnel that has previously agreed to work the additional hours for receiving the one or more communication signals.

In one aspect, the controller is configured to only send the one or more communication signals to the at least one of the available workforce personnel or additional workforce personnel that has previously agreed to work the additional hours and to not send the one or more communication signals to the at least one of the available workforce personnel or additional workforce personnel that have not previously agreed to work the additional hours.

In one aspect, the controller also is configured to determine which of the at least one of the available workforce personnel or additional workforce personnel has been previously approved to work additional hours by a third person prior to calculating the labor shortfall and selecting the at least one of the available workforce personnel or additional workforce personnel that has been previously approved to work the additional hours for receiving the one or more communication signals.

In one aspect, the controller is configured to send the one or more communication signals only to the at least one of the available workforce personnel or additional workforce personnel that has been previously approved to work the additional hours and not to the at least one of the available workforce personnel or additional workforce personnel that have not been previously approved to work the additional hours.

In one aspect, the controller is configured to direct the electronic device of the operator to display one or more visual indicia representative of at least one of progress or problems with the set of tasks during work on the set of tasks.

In another example of the inventive subject matter described herein, another method (e.g., for scheduling and/or monitoring a workforce) includes estimating a needed amount of workforce personnel to complete a scheduled set of tasks on a vehicle asset to at least one of repair the vehicle asset, maintain the vehicle asset, or prepare the vehicle asset for departure, determining an available amount of the workforce personnel that can perform at least part of the scheduled set of tasks within an upcoming designated time period subject to one or more workforce constraints on a length of time that the workforce personnel is allowed to work during the upcoming designated time period, comparing the needed amount of the workforce personnel with the available amount of the workforce personnel to identify a labor shortage for the scheduled set of tasks, notifying an operator of the labor shortage on an electronic mobile device of the operator, and, responsive to receiving input from the operator via the mobile device of the operator, at least one of: identifying additional workforce personnel to assist with performance of the scheduled set of tasks in excess of the one or more workforce constraints in order to reduce or eliminate the labor shortage, or changing a scheduled order of the tasks to reduce or eliminate the labor shortage.

In one aspect, changing the scheduled order of the tasks includes determining if two or more of the tasks are subject to a restriction that prevents changing the order of the two or more of the tasks.

In one aspect, identifying the additional workforce personnel includes determining that the additional workforce personnel previously were approved to work in excess of the one or more workforce constraints.

In one aspect, identifying the additional workforce personnel includes selecting the additional workforce personnel based on areas of expertise of the additional workforce personnel being needed to complete the scheduled set of tasks.

In the specification and claims, reference will be made to a number of terms having the following meanings The singular forms “a”, “an” and “the” include plural references unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

The terms “including” and “having” are used as the plain language equivalents of the term “comprising”; the term “in which” is equivalent to “wherein.” Moreover, unless explicitly stated to the contrary, embodiments “comprising,” “including,” or “having” an element or a plurality of elements having a particular property may include additional such elements not having that property. Furthermore, references to “one embodiment” of the inventive subject matter are not intended to be interpreted as excluding the existence of additional embodiments that also incorporate the recited features. Moreover, certain embodiments may be shown as having like or similar elements, however, this is merely for illustration purposes, and such embodiments need not necessarily have the same elements unless specified in the claims.

This written description uses examples to disclose the inventive subject matter, including the best mode, and also to enable one of ordinary skill in the art to practice the inventive subject matter, including making and using any devices or systems and performing any incorporated methods. The embodiments described herein are examples of articles, systems, and methods having elements corresponding to the elements of the inventive subject matter recited in the claims. This written description may enable those of ordinary skill in the art to make and use embodiments having alternative elements that likewise correspond to the elements of the inventive subject matter recited in the claims. The scope of the inventive subject matter thus includes articles, systems and methods that do not differ from the literal language of the claims, and further includes other articles, systems and methods with insubstantial differences from the literal language of the claims. While only certain features and embodiments have been illustrated and described herein, many modifications and changes may occur to one of ordinary skill in the relevant art. This application covers all such modifications and changes.

1. A method comprising:
calculating, with one or more computer processors, a labor shortfall for completion of a set of tasks within a designated time period, the labor shortfall representing a difference between an amount of required workforce personnel that is needed to complete the set of tasks within the designated time period and an amount of available workforce personnel during the designated time period, the available workforce personnel subject to one or more workforce constraints on how long the available workforce personnel can work within the designated time period;
visually presenting, with the one or more computer processors on an electronic device of an operator, an indication of the labor shortfall; and
responsive to receiving first operator input on the electronic device of the operator, automatically generating one or more communication signals that are sent to one or more mobile devices of at least one of the available workforce personnel or additional workforce personnel, the one or more communication signals requesting additional work on the set of tasks by the at least one of the available workforce personnel or the additional workforce personnel in excess of the one or more workforce constraints.

2. The method of claim 1, further comprising:
determining a first order in which the tasks are to be completed within the designated time period, wherein the labor shortfall is calculated based on the first order in which the tasks are to be completed; and
responsive to receiving second operator input on the electronic device of the operator, determining a different, second order in which the tasks are to be completed, wherein the set of tasks cannot be completed within the designated time period with the available workforce personnel when completed in the first order but can be completed within the designated time period with the available workforce personnel when completed in the second order.

3. The method of claim 1, wherein the one or more workforce constraints include contractual limitations on working hours of the available workforce personnel.

4. The method of claim 1, further comprising determining which of the at least one of the available workforce personnel or additional workforce personnel has previously agreed to work additional hours prior to calculating the labor shortfall and selecting the at least one of the available workforce personnel or additional workforce personnel that has previously agreed to work the additional hours for receiving the one or more communication signals.

5. The method of claim 4, wherein the one or more communication signals are only sent to the at least one of the available workforce personnel or additional workforce personnel that has previously agreed to work the additional hours and are not sent to the at least one of the available workforce personnel or additional workforce personnel that have not previously agreed to work the additional hours.

6. The method of claim 1, further comprising determining which of the at least one of the available workforce personnel or additional workforce personnel has been previously approved to work additional hours by a third person prior to calculating the labor shortfall and selecting the at least one of the available workforce personnel or additional workforce personnel that has been previously approved to work the additional hours for receiving the one or more communication signals.

7. The method of claim 6, wherein the one or more communication signals are only sent to the at least one of the available workforce personnel or additional workforce personnel that has been previously approved to work the additional hours and are not sent to the at least one of the available workforce personnel or additional workforce personnel that have not been previously approved to work the additional hours.

8. The method of claim 1, further comprising displaying, on the electronic device of the operator, one or more visual indicia representative of at least one of progress or problems with the set of tasks during work on the set of tasks.

9. A system comprising:
a controller comprising one or more computer processors, the controller configured to identify a labor shortfall for completion of a set of tasks within a designated time period, the labor shortfall representing a difference between an amount of required workforce personnel that is needed to complete the set of tasks within the designated time period and an amount of available workforce personnel during the designated time period, the available workforce personnel subject to one or more workforce constraints on how long the available workforce personnel can work within the designated time period,
wherein the controller also is configured to direct an electronic device of an operator to visually present an indication of the labor shortfall, the controller also configured to receive first operator input via the electronic device of the operator and, responsive to receiving the first operator input, automatically generate one or more communication signals that are sent to one or more mobile devices of at least one of the available workforce personnel or additional workforce personnel, the one or more communication signals requesting additional work on the set of tasks by the at least one of the available workforce personnel or the additional workforce personnel in excess of the one or more workforce constraints.

10. The system of claim 9, wherein the controller also is configured to determine a first order in which the tasks are to be completed within the designated time period, wherein the labor shortfall is calculated based on this first order in which the tasks are to be completed, and wherein the controller is configured to, responsive to receiving second operator input on the electronic device of the operator, determine a different, second order in which the tasks are to be completed, wherein the set of tasks cannot be completed within the designated time period with the available workforce personnel when completed in the first order but can be completed within the designated time period with the available workforce personnel when completed in the second order.

11. The system of claim 9, wherein the one or more workforce constraints include contractual limitations on working hours of the available workforce personnel.

12. The system of claim 9, wherein the controller is configured to determine which of the at least one of the available workforce personnel or additional workforce personnel has previously agreed to work additional hours prior to calculating the labor shortfall, the controller also configured to select the at least one of the available workforce personnel or additional workforce personnel that has previously agreed to work the additional hours for receiving the one or more communication signals.

13. The system of claim 12, wherein the controller is configured to only send the one or more communication signals to the at least one of the available workforce personnel or additional workforce personnel that has previously agreed to work the additional hours and to not send the one or more communication signals to the at least one of the available workforce personnel or additional workforce personnel that have not previously agreed to work the additional hours.

14. The system of claim 9, wherein the controller also is configured to determine which of the at least one of the available workforce personnel or additional workforce personnel has been previously approved to work additional hours by a third person prior to calculating the labor shortfall and selecting the at least one of the available workforce personnel or additional workforce personnel that has been previously approved to work the additional hours for receiving the one or more communication signals.

15. The system of claim 14, wherein the controller is configured to send the one or more communication signals only to the at least one of the available workforce personnel or additional workforce personnel that has been previously approved to work the additional hours and not to the at least one of the available workforce personnel or additional workforce personnel that have not been previously approved to work the additional hours.

16. The system of claim 9, wherein the controller is configured to direct the electronic device of the operator to display one or more visual indicia representative of at least one of progress or problems with the set of tasks during work on the set of tasks.

17. A method comprising:
estimating a needed amount of workforce personnel to complete a scheduled set of tasks on a vehicle asset to at least one of repair the vehicle asset, maintain the vehicle asset, or prepare the vehicle asset for departure;
determining an available amount of the workforce personnel that can perform at least part of the scheduled set of tasks within an upcoming designated time period subject to one or more workforce constraints on a length of time that the workforce personnel is allowed to work during the upcoming designated time period;
comparing the needed amount of the workforce personnel with the available amount of the workforce personnel to identify a labor shortage for the scheduled set of tasks;
notifying an operator of the labor shortage on an electronic mobile device of the operator; and
responsive to receiving input from the operator via the mobile device of the operator, at least one of: identifying additional workforce personnel to assist with performance of the scheduled set of tasks in excess of the one or more workforce constraints in order to reduce or eliminate the labor shortage, or changing a scheduled order of the tasks to reduce or eliminate the labor shortage.

18. The method of claim 17, wherein changing the scheduled order of the tasks includes determining if two or more of the tasks are subject to a restriction that prevents changing the order of the two or more of the tasks.

19. The method of claim 17, wherein identifying the additional workforce personnel includes determining that the additional workforce personnel previously were approved to work in excess of the one or more workforce constraints.

20. The method of claim 17, wherein identifying the additional workforce personnel includes selecting the additional workforce personnel based on areas of expertise of the additional workforce personnel being needed to complete the scheduled set of tasks.
